(19) United States
(12) Patent Application Publication
(10) Pub. No.: US 2003/0014599 A1
(43) Pub. Date: Jan. 16, 2003

(54) Method for providing a configurable primary mirror

(75) Inventors: Gerald Francis McBrearty, Austin, TX (US); Shawn Patrick Mullen, Buda, TX (US); Johnny Meng-Han Shieh, Austin, TX (US)

Correspondence Address: Andrea Pair Bryant, 5202 Vista West Cove, Austin, TX, 78731-1163, US

(73) Assignee: International Business Machines Corporation, Armonk, NY (US)

(21) Appl. No.: 09/899,452

(22) Filed: Jul. 5, 2001

(51) Int. Cl. G06F 13/00

(52) U.S. Cl. 711/148

(57) ABSTRACT

There is disclosed an improved method for increasing performance in multiprocessing parallel computing systems, comprising plural processor resource groups sharing a storage subsystem, by reducing contention during read attempts through assigning each processor resource group a primary mirror. Mirrors may be designated as primary by the administrator during system configuration. Thereafter read requests originating in a given processor resource group are first attempted on the primary mirror previously associated with that processor resource group. If that mirror is unavailable, another mirror is chosen via a default mirror selection process.

### BACKGROUND OF THE INVENTION

1. Field of the Invention

The present invention relates to information handling system. More particularly, it relates to a method for reducing read contention during reads in a multiprocessor system utilizing mirrored logical volumes for storing data.

2. Description of the Prior Art

In data processing environments where system performance and throughput are important it is often desirable to maintain multiple copies of data. Maintaining multiple copies increases data availability and decreases possibilities of data loss due to hardware failures. One method used is for maintaining multiple copies of data is mirroring. Mirroring is a form of RAID (Redundant Array of Independent Disks) and is implemented by storing two or more copies of data on two or more different disks. Data may be read from any of the disks on which it is stored, so long as the disk is available.

In typical systems each disk drive is referred to as a physical volume and is given a unique name. Each physical volume in use belongs to a volume group. The physical volumes in a volume group are divided into physical partitions of equal size. Within each volume group one or more logical volumes may be defined. Data on a logical volume appears to be contiguous to a user, but is usually discontiguous on the physical volume. Each logical volume is divided into one or more logical partitions, where each logical partition corresponds to one or more physical partitions. When mirroring is implemented additional physical partitions are used for storing additional copies, mirrors, of each logical partition.

In smaller systems several I/O scheduling policies are known. Two are parallel and sequential mirroring. In parallel mirroring a read operation occurs data is read from the disk whose disk head is considered to be physically closest to the address location of the requested data. In sequential mirroring one mirror is designated at the primary mirror and the other mirror(s) are designated as secondary mirrors. In this case, read operations are directed to the primary mirror, then to each secondary mirror.

In commonly assigned U.S. Pat. No. 6,105,118 to Maddalozza, Jr. et al. another method is disclosed for selecting from which disk to read. When a read request is received, each mirror is checked to determine which disk contains the fewest relocated blocks within the desired read area, and the data is read from there.

U.S. Pat. No. 5,987,566 to Vishlitzky discloses diverse reading processes which may be assigned to each logical volume in a redundant storage with mirroring.

Commonly assigned U.S. Pat. No. 6,041,366 to Maddalozza, Jr. et al. Discloses dynamically specifying, by I/O transaction, certain attributes such as the primary mirror.

In today's large multiple processor systems data availability is ever more a critical issue. Some multiple processor systems are used for concurrent, parallel processing. There may be many processor resource groups, each having plural processors handling data. Generally, a processor resource group may be defined as any collection of one or more processors the grouping of which is based their common access and latency with regard to physical resources such as memory. A single computer may be a processor resource group and each processor in a multiprocessor system could be defined as a processor resource group.

In such systems data mirroring is especially important. Mirroring is implemented for each processor resource group. Unlike the situation in smaller systems such as those in the prior art references above, in large multiprocessor systems, I/O, especially read operations, can be even more problematic from a system performance perspective. Existing mirror selection techniques are inapplicable. Since there are so many more read attempts in a clustered processor, concurrent processing environment, always reading from a single primary mirror leads to highly likely and very time consuming contention for that mirror.

There are two types of large multiprocessor systems, clustered and NUMA (Non-Uniform Memory Access) in which the problem of disk contention for read operations may arise. Both clustered and NUMA systems are parallel processing environments. In clustered environments, which are usually defined as a collection of computers on a network which can function as a single computing resource, the system may be viewed as one logical system with distributed resources. Each machine in a cluster is defined as processor resource group. A cluster system may be managed from a single point of control. Clustering improves overall system availability and permits scaling to hundreds of processors.

Another type of multiprocessing architecture is Symmetric Multiprocessing (SMP) wherein plural processor resource groups complete individual processes simultaneously. SMP uses a single operating system and shares common memory and I/O resources. Massive parallel processing systems provide separate memory for each processor resource group, and unlike SMP have fewer bottleneck problems arising from plural processor resource groups attempt access to the same memory.

In NUMA systems each node is defined as a processor resource group. Each processor resource group has its own memory, but can also access memory associated with other processors. NUMA nodes, or sets of processors, are connected to achieve the non uniform access latencies associated with such systems. Memory access is non-uniform because memory access time is a function of memory location. That is, a processor resource group can access its own memory more quickly than memory which is non-local, associated with another processor resource group.

If reads are issued in accord with a round robin or least busy disk scheduling policy in a clustered environment there is no cluster control over which mirror to choose. The time and resource usage involved in communication throughout a clustered environment is expensive, as are references to mirror(s) not associated with the processor resource group in which the read request arises in a NUMA environment.

The use of mirroring can improve performance in multiple processor resource group systems for read requests so long as the processor resource groups do not attempt to read from the same storage device at the same times. It would be possible to have processor resource groups communicate with each other prior to issuing a read request, but the overhead of so doing would considerably slow throughput for all of the processor resource groups.

Thus, it would be desirable to have a method for choosing a particular mirror in clustered and NUMA multiprocessor system environments that would eliminate unnecessary, time consuming contention during read operations. I/O performance would therefore be improved.

### SUMMARY OF THE INVENTION

The present invention overcomes the shortcomings of prior art mirror selection techniques by providing a configurable primary mirror for use in clustered and NUMA systems. In order to exert control over mirror selection for reads in a clustered multiprocessor system, the present invention provides for setting by a system administrator, or via software control, a primary mirror for each processor resource group, thereby allowing only reads from the processor resource group for which a given primary mirror is designated. For NUMA environments, the present invention provides for the administrator or logical volume device driver (LVDD) to determine the primary mirror(s) for each processor resource group.

The present invention provides for the designation of one or more primary mirrors for each processor resource group at system configuration. Once running, and a read is requested, a system embodying the present invention first checks for a designated primary mirror, and if found and available executes the read. If no primary mirror has been designated, or the designated mirror is inactive or otherwise unavailable, a default mirror selection technique is used.

### BRIEF DESCRIPTION OF THE DRAWING

The foregoing and other features and advantages of the present invention will become more apparent from the following description of the best mode for carrying out the invention taken in conjunction with the various figures of the drawing in which like numerals and symbols are used throughout to designate like elements, and in which:

FIG. 1 is a high level block diagram of a multiple processor information handling system in which the present invention may be used;

FIG. 2 illustrates in more detail disk storage subsystem 40 of FIG. 1;

FIG. 3 shows a procedure for designating a primary mirror for every processor resource group;

FIG. 4 shows a procedure for designation of a different mirror for each processor resource group;

FIG. 5 shows an SMP system which may utilize the present invention; and

FIG. 6 is a flow chart of the logic followed by a logical volume device driver in accordance with the present invention.

### DETAILED DESCRIPTION OF THE INVENTION

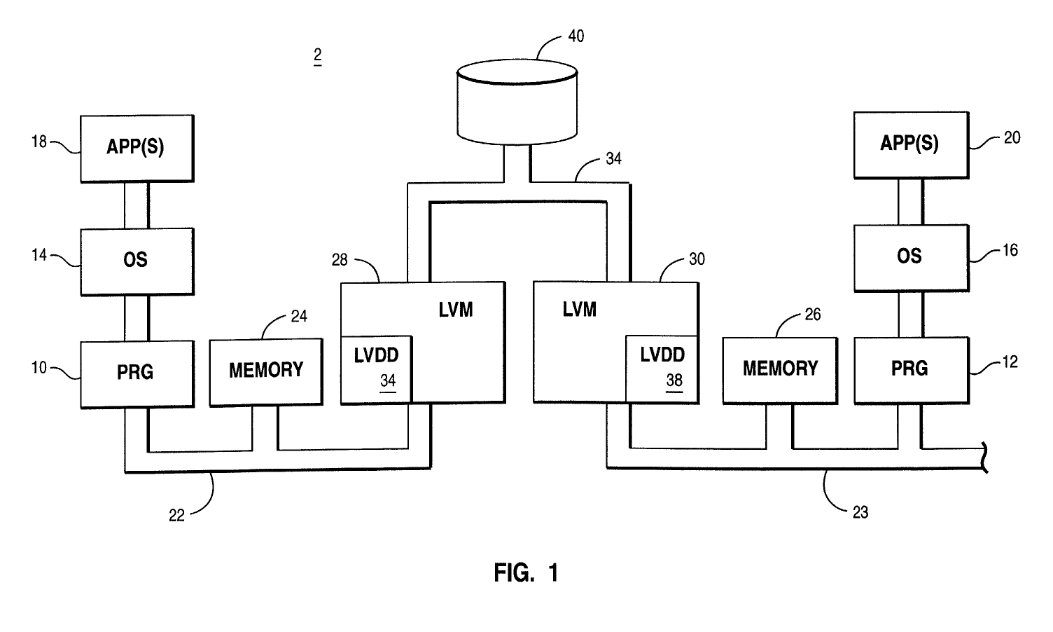

Refer now to FIG. 1 which illustrates the major components of a multiple processor system 2 in which the present invention may be practiced. The computer system of FIG. 1 includes at least one processor resource groups (PRG) 10, 12. Operating systems 14, 16 run on PRGs 10 and 12 respectively, providing control and coordinating functions of the various components of system 2. One or more user applications 18, 20 may execute in PRGs 10, 12. Each PRG 10, 12 is interconnected via its own bus 22, 23, respectively, to its own memory 24, 26 as well as to a logical volume manager (LVM) 28, 30. LVMs 28, 30 each include a logical volume device driver (LVDD) 34, 38, and each LVM 28, 30 is connected over bus 34 to disk storage subsystem 40. As is known by those skilled in the art, each LVM also includes kernel memory (not shown), one function of which will be described below in connection with the designation of a primary mirror.

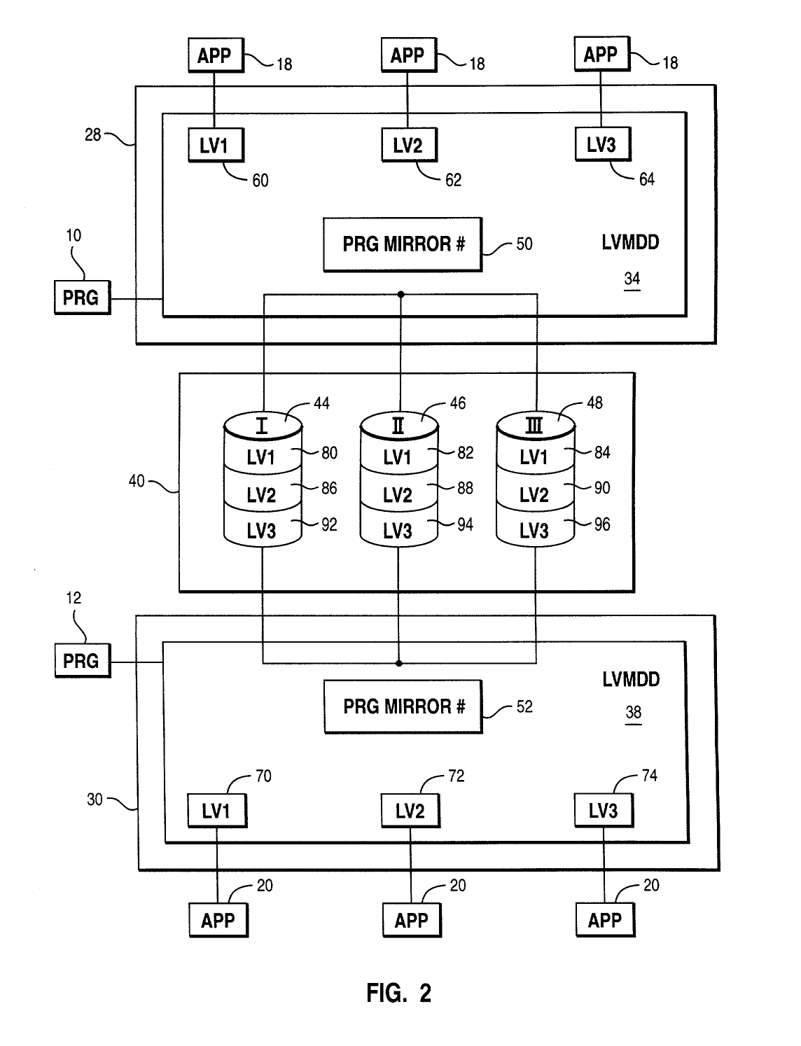

Have reference now to FIG. 2, for a more detailed description of the logical volumes and their mirrors associated with PRGs 10 and 12 (FIG. 1). FIG. 2 is useful in understanding the relationship among the logical volumes and physical volumes comprising disk storage subsystem 40 (FIG. 1) and their associated LVMs. LVMs 28 and 30 control and manage disk resources by mapping data between the logical view of storage as used by application programs and actual physical disks. LVMs 28 and 30 accomplish this mapping via LVDDs 34 and 38, respectively. LVDDs manage and process I/O requests to specific device drivers (not shown). LVDDs translate logical addresses from applications 18 and 20 as well as from operating systems 14 and 16 into physical addresses, and send I/O requests to specific device driver.

In FIG. 2. disk storage subsystem 40 is shown comprising three physical volumes, 44, 46, and 48. Stated differently, disk storage subsystem 40 includes three mirrored disks labeled I, II and III, respectively. Each physical volume includes three logical volumes (LV), LV1, LV2 and LV3.

FIG. 2 shows each LVMDD 34, 38 from FIG. 1 to include a storage location 50, 52, respectively for storing the identifier of its designated primary mirror. Application 18, being executed by PRG 10, is here shown as 18i, 18ii and 18iii. Application 18i uses LV1 60; application, 18ii, LV2 62; and application 18iii, LV3 64. PRG 12 is executing application which is here shown as applications 20i, 20ii, and 20iii, using LV1 70, LV2 72, and LV3 74, respectively LV1 appears in physical volume 44, 46 and 48 as shown at areas 80, 82 and 84 respectively. LV2 is also stored on each physical volume as indicated at 86, 88, and 90, respectively. LV3 appears on each mirror as represented at 92, 94 and 96, respectively.

The key concept of the present invention is configuring a designated primary mirror for each PRG, in this case, each of PRGs 10 and 12. Assigning different physical volumes as primary mirrors for each PRG alleviates contention during reads because every processor in system 2 will no longer use the same volume as its primary read target as a matter of course.

In accordance with the present invention, designation of a primary mirror occurs at system configuration. The administrator of a system such as shown in FIG. 1, may by using an interactive console enter instructions to assign mirror number I, which comprises logical volumes LV1 80, LV2 86 and LV3 92, to PRG 10 by storing the identifier of mirror I, located on physical volume 44, in LVMDD 34 mirror storage location 50.

In a similar manner, mirror II on physical volume 46 may be assigned to PRG 12. Mirror II comprises three logical volumes, LV1 82, LV2 88 and LV3 96. The identifier of mirror II is stored in LVMDD 38 mirror storage location 52.

In a product such as the IBM AIX HACMP, available from the International business Machines Corp., for managing high availability cluster computing systems, the present invention may be utilized in a manner requiring no direct administrator action.

Thereafter, until system 2 is reconfigured, all reads emanating from PRG 10 will be first attempted on physical volume 44 since LVMDD 34 includes mirror I in its PRG mirror number storage location 50. Physical volume 44 contains the mirrors of the logical volumes 60, 62 and 64 being accessed by application 18. All reads from PRG 12 will be first tried on physical volume 46 which contains mirrors of logical volumes 70, 72, 74 accessed by application 20. Thus, reads from PRG 10 will only execute on physical volumes 48 or 46 (mirror III or mirror II) if for some reason physical volume 44 (mirror I) is unavailable. Likewise, reads from PRG 12 will execute on physical volumes 48 or 44 (mirror III or mirror I) only when physical volume 46 is unavailable.

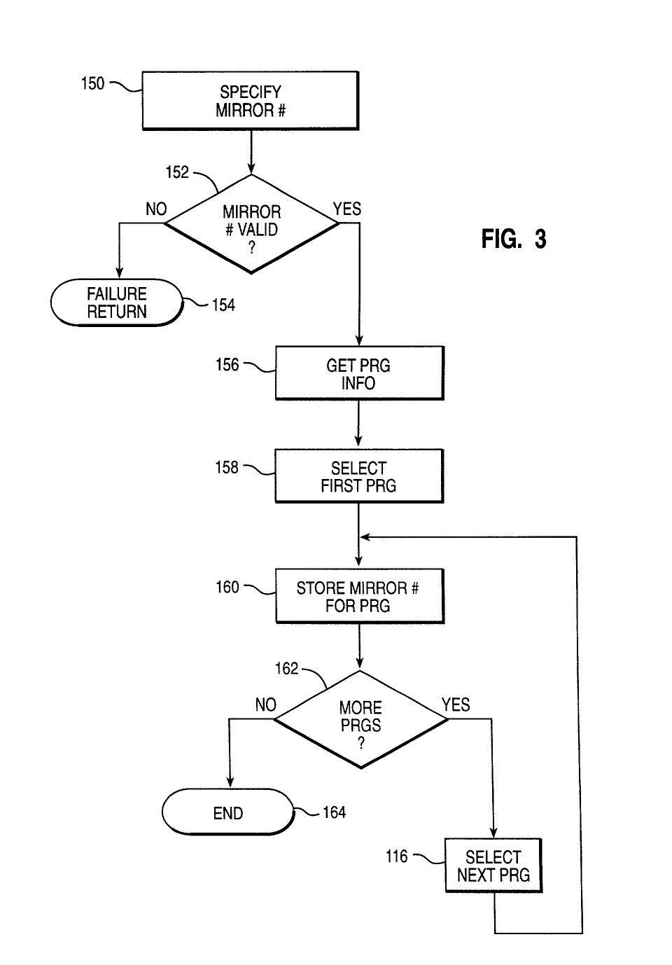

Refer now to FIG. 3 for an understanding of the procedure followed in accordance with the present invention for designating the same primary mirror for every PRG in a system such as system 2, FIG. 1. At step 150 the process for specifying the same mirror begins. A determination is made at query 152 whether the mirror identification number is valid. If not, an operation failure message is returned at step 154. If the mirror identification number is valid, then at step 156, pertinent PRG information is obtained. Step 158 represents selecting the first PRG in the system, and at step 160 the mirror identification number is stored in the LVM kernel memory of that PRG. Query step 162 represents the determination whether there is another PRG in the system. If not, the procedure terminates normally at step 164. If there is another PRG, then at step 166 the next PRG is selected and the procedure returns to step 160 and repeats the mirror designation procedure.

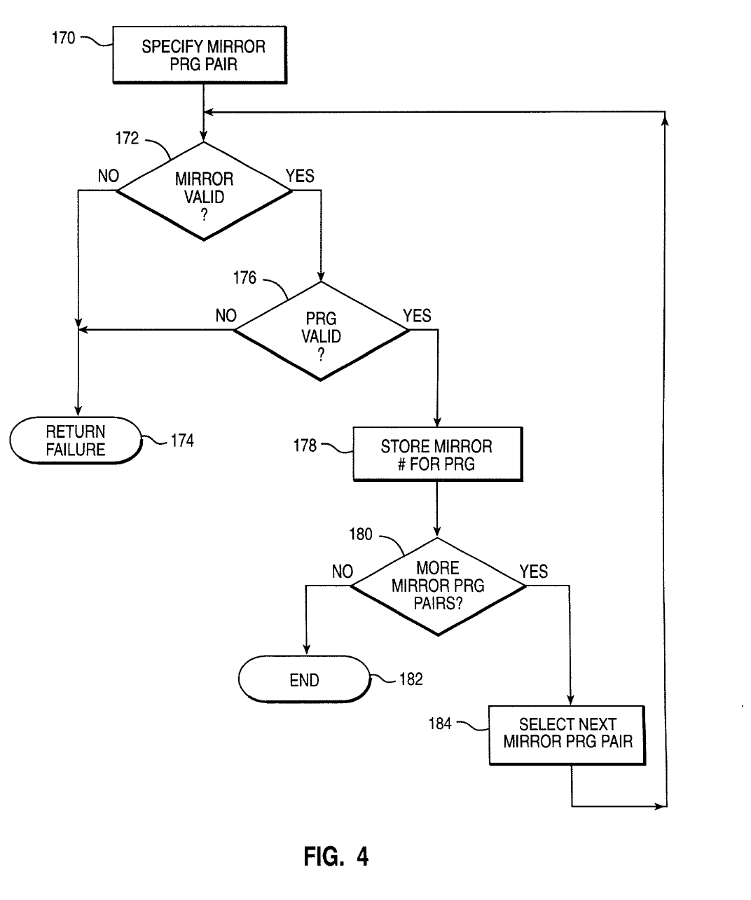

FIG. 4 shows the process followed when it is desired to designate a different mirror for each PRG in a system such as system 2, FIG. 1. The process begins at step 170 when the first PRG mirror pair is specified. At step 172 it is determined whether a valid mirror identification number has been provided. If not, then an operation failure message is returned at step 174. If the mirror identification number is valid a query is made at step 176 as to the validity of the PRG identification. If the PRG identification is found to be invalid the process terminates with an operation failure message returned at step 174. When both members of the PRG mirror pair are found to be valid, the mirror identification number is stored as indicated at step 178 in the kernel memory of the LVM of the PRG. At decision step 180 it is determined whether more PRG mirror pairs have been specified. If not, the process terminates normally at step 182. If there is another PRG mirror pair, it is selected at step 184. The process then returns to step 172 to repeat the mirror identification number designation.

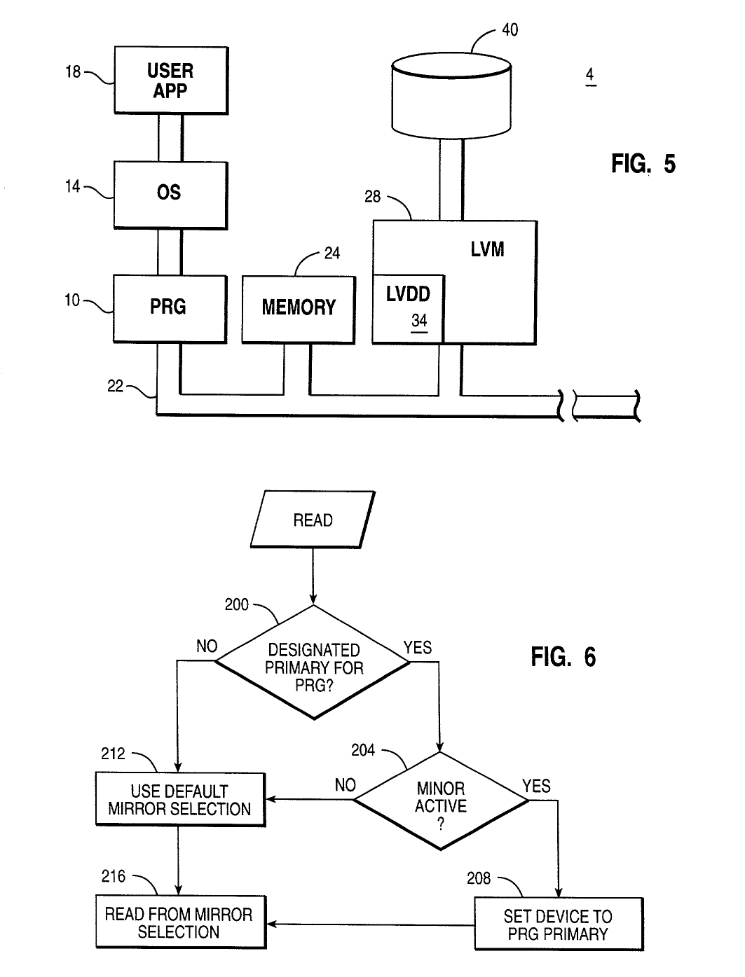

The present invention has particular utility in cluster and NUMA environments, but it may be used, as well, with a system such as system 4 shown in FIG. 5. System 4 represents a stand alone NUMA or SMP environment which will experience improved performance when the present invention is incorporated therein. The components shown in FIG. 5 perform the same functions as the components of FIG. 1 having the same reference numerals. The operation of the present invention allowing for configurable primary mirrors is the same.

Refer now to FIG. 6 for an understanding of the logic followed within LVDDs 34 and 38 of system 2 (FIG. 1) in utilizing the present invention. For the sake of clarity, the operation of the invention in processing a single read originating in PRG 10 will be described. At decision step 200, LVDD 28 in seeking to execute that read, first determines if PRG has a designated primary mirror. Recall that physical volume 44 was designated to be the primary mirror per the above description of FIG. 2. If a primary mirror was assigned, then at decision step 204 LVDD 34 determines whether that assigned primary mirror is active. If so, control passes to step 208 where the device is set to the designated primary mirror, physical volume 44, and the read occurs at step 216.

If the mirror, physical volume 44, designated for PRG 10 is stale or otherwise unavailable, a branch is made to step 212 at which a default mirror selection method occurs. The read operation is then made from a different mirror, either physical volume 46 or 48. It will be understood by those having skill in the art that another technique for mirror selection may be used. Those having skill in the art will appreciate that a default method could include looking for the least busy mirror associated with a given PRG by examining the number of reads issued from each processor in the PRG and thereafter setting the device to read from the mirror with the fewest pending reads. Operation of system 2 continues as is well understood in the art until another read is issued from a PRG and the logic just described in connection with FIG. 6 is repeated.

While the present invention has been described having reference to a particular preferred embodiment, those having skill in the art will appreciate that the above and other modifications in form and detail may be made without departing from the spirit and scope of the following claims.

What is claimed is:

1. A method for increasing performance in a multiprocessor concurrent computing system having a plurality of processor resource groups sharing a storage subsystem with mirrored logical volumes, comprising:
designating a primary mirror for each processor resource group at system configuration;
during run time, attempting read requests originating in a given processor resource group first on said primary mirror designated for that processor resource group; and
executing said read request on another mirror only if said primary mirror is unavailable, said another mirror being chosen in accord with a default mirror selection process.

2. The method of claim 1 wherein said multiprocessor concurrent computing system is a cluster computing system.

3. The method of claim 1 wherein said multiprocessor concurrent computing system is a NUMA system.

4. The method of claim 1 wherein said designating step comprises:
storing a specific mirror identification number in logical volume manager kernel memory for each processor resource group.

5. The method of claim 4 wherein said attempting step includes:
determining whether said primary mirror is active or stale; and
when said primary mirror is active, setting a device to read therefrom.

6. The method of claim 5 wherein said executing step includes:
when said primary mirror is stale, setting a device to read from a randomly chosen other mirror.

7. The method of claim 1 wherein said designating step comprises:
storing a specific mirror identification number in logical volume manager kernel memory for a selected processor resource group

8. Apparatus for increasing performance in a multiprocessor concurrent computing system having a plurality of processor resource groups sharing a storage subsystem with mirrored logical volumes, comprising:
means for designating a primary mirror for each processor resource group at system configuration;
means active during run time, for attempting read requests originating in a given processor resource group first on said primary mirror designated for that processor resource group; and
means executing said read request on another mirror only if said primary mirror is unavailable, said another mirror being chosen in accord with a default mirror selection process.

9. The apparatus of claim 8 wherein said multiprocessor concurrent computing system is a cluster computing system.

10. The apparatus of claim 9 wherein said multiprocessor concurrent computing system is a NUMA system.

11. The method of claim 8 wherein said means for designating comprises:
means for storing a specific mirror identification number in logical volume manager kernel memory for each processor resource group.

12. The apparatus of claim 11 wherein said means for attempting includes:
means for determining whether said primary mirror is active or stale; and
means, when said primary mirror is active, for setting a device to read therefrom.

13. The apparatus of claim 12 wherein said means for executing includes:
means, when said primary mirror is stale, for setting a device to read from a randomly chosen other mirror.

14. The apparatus of claim 8 wherein said means for designating comprises:
means for storing a specific mirror identification number in logical volume manager kernel memory for a selected processor resource group.

15. A computer readable medium for increasing performance in a multiprocessor concurrent computing system having a plurality of processor resource groups sharing a storage subsystem with mirrored logical volumes, comprising:
means for designating a primary mirror for each processor resource group at system configuration;
means active during run time, for attempting read requests originating in a given processor resource group first on said primary mirror designated for that processor resource group; and
means executing said read request on another mirror only if said primary mirror is unavailable, said another mirror being chosen in accord with a default mirror selection process.

16. A computer readable medium according to claim 15 wherein said multiprocessor concurrent computing system is a cluster computing system.

17. A computer readable medium according to claim 15 wherein said multiprocessor concurrent computing system is a NUMA system.

18. A computer readable medium according to claim 15 wherein said means for designating comprises:
means for storing a specific mirror identification number in logical volume manager kernel memory for each processor resource group.

19. A computer readable medium according to claim 18 wherein said means for attempting includes:
means for determining whether said primary mirror is active or stale; and
means, when said primary mirror is active, for setting a device to read therefrom.

20. A computer readable medium according to claim 19 wherein said means for executing includes:
means, when said primary mirror is stale, for setting a device to read from a randomly chosen other mirror.

21. A computer readable medium according to claim 15 wherein said means for designating comprises:
means for storing a specific memory identification number in logical volume manager kernel memory for a selected processor resource group.
